(19) United States
(12) Patent Application Publication
(10) Pub. No.: US 2012/0297082 A1
(43) Pub. Date: Nov. 22, 2012

(54) METHOD AND SYSTEM FOR DISTRIBUTING MEDIA CONTENT OVER A WIRELESS NETWORK

(75) Inventor: Wong Hoo Sim, Singapore (SG)

(73) Assignee: CREATIVE TECHNOLOGY LTD, Singapore (SG)

(21) Appl. No.: 13/519,289

(22) PCT Filed: Dec. 17, 2010
(86) PCT No.: PCT/SG2010/000477

§ 371 Date: Jun. 26, 2012

(30) Foreign Application Priority Data
Jan. 4, 2010 (SG) 201000008-1

(51) Int. Cl. G06F 15/16; H04W 8/00

(52) U.S. Cl. 709/231

(57) ABSTRACT

There is provided a method and system for distributing media content over a wireless network. There may be at least one primary stream of media content and the at least one secondary stream of media content being transmitted either simultaneously or with a time lag. Preferably, the at least one primary stream of media content takes up a substantially higher bandwidth over the wireless network compared to the at least one secondary stream of media content, and the at least one primary stream of media content is dropped by a signal receiver at areas of the wireless network with a degraded signal of the at least one primary stream of media content, where the degraded signal may be in a form which is not readable.

### FIELD OF INVENTION

The present invention relates to the field of distribution of media content, primarily in relation to methods of transmitting/receiving the media content and the system for enabling the distribution of media content.

### BACKGROUND

The development and widespread availability of high bandwidth wireless networks has led to voluminous amounts of digital data being transmitted wirelessly as the high bandwidth and wireless nature enables the transmission of the digital data to be carried out conveniently for the user. However, there are currently limitations in relation to the range of the high bandwidth wireless networks, especially in areas with a high density of obstructions, such as, for example, buildings, elevated land formations, forested areas, and so forth.

In a typical metropolis in any country, the high density of buildings (regardless of height) invariably causes signal degradation in the high bandwidth wireless networks as the buildings form obstructions for transmitted signals from a wireless transmitter used in a high bandwidth wireless network. The transmitted signals may “bounce” off the obstructions, where with each instance of the “bounce” off the obstructions, a separate instance of the original transmitted signal makes its way to a signal receiver with a variation in time. These multiple “bounced” signals typically interfere with one another at the signal receiver which consequently results in a degraded signal being received at the signal receiver.

Furthermore, it should be noted that in areas with a high density of buildings, a received signal at a further location from the wireless transmitter would likely be degraded to a greater extent compared to a received signal at a nearer location from the wireless transmitter. This is because of the greater variation in relation to a time that the multiple “bounced” signals are received at the further location from the wireless transmitter, where the variation may be due to, for example, high incidence of signal “bouncing”, interference with the signals, and so forth. In this regard, the degradation of the transmitted signal to the further location may be to an extent where the transmitted signal may not be readable at the signal receiver despite the application of data error correction techniques to the signals received at the signal receiver. Thus, it is evident that there are some issues in relation to wirelessly transmitting voluminous amounts of digital data over long distances as recipients at the long distance locations may not be able to read the transmitted signal upon receipt of degraded signals. Consequently, the recipients would unfortunately not be able to consume the content stored in the degraded signals.

It is desirable that the aforementioned issues are addressed to ensure that data transmission over wireless networks is more robust.

### SUMMARY

In a first aspect, there is provided a method for transmitting at least one stream of media content over a wireless network from a signal transmitter in the wireless network. The signal transmitter may be coupled to a media content repository. The method includes transmitting at least one primary stream of media content in high definition format; and transmitting at least one secondary stream of media content in any format lower than high definition format, the at least one secondary stream of media content containing identical content to the at least one primary stream of media content. The at least one primary stream of media content and the at least one secondary stream of media content may be transmitted either simultaneously or with a time lag.

Preferably, the at least one primary stream of media content takes up a substantially higher bandwidth over the wireless network compared to the at least one secondary stream of media content, and the at least one primary stream of media content is dropped by a signal receiver at areas of the wireless network with a degraded signal of the at least one primary stream of media content, where the degraded signal may be in a form which is not readable. The substantially higher bandwidth may relate to a maximum of 90% of an available bandwidth of the wireless network.

The wireless network may be selected from, for example, WiMax, HSDPA, 4G and so forth. The format lower than high definition format may be in relation to image resolution of the media content.

The signal receiver may preferably be incorporated into a device such as, for example, a mobile phone, a media player, an e-book reader, a desktop computer, a portable computer and the like.

In a second aspect, there is provided a method for receiving at least one stream of media content over a wireless network at a signal receiver in the wireless network. The wireless network may be selected from, for example, WiMax, HSDPA, 4G and so forth. The method includes receiving at least one primary stream of media content in high definition format; receiving at least one secondary stream of media content in any format lower than high definition format, the at least one secondary stream of media content containing identical content to the at least one primary stream of media content; and dropping the at least one primary stream of media content at areas of the wireless network with a degraded signal of the at least one primary stream of media content. Preferably, the format lower than high definition format is in relation to image resolution of the media content. The degraded signal may be in a form which is not readable.

It is preferable that the at least one primary stream of media content takes up a substantially higher bandwidth over the wireless network compared to the at least one secondary stream of media content, with the substantially higher bandwidth relating to a maximum of 90% of an available bandwidth of the wireless network. The at least one primary stream of media content and the at least one secondary stream of media content may be received either simultaneously or with a time lag.

It is preferable that the signal receiver is incorporated into a device such as, for example, a mobile phone, a media player, an e-book reader, a desktop computer, a portable computer and the like.

In a final aspect, there is provided a system for distributing media content over a wireless network. The wireless network may be selected from, for example, WiMax, HSDPA, 4G and the like. The system includes at least one media content repository able to transmit at least one primary stream of media content in high definition format and at least one secondary stream of media content in any format lower than high definition format, the at least one secondary stream of media content containing identical content to the at least one primary stream of media content; and at least one wireless receiver device able to receive the at least one primary stream of media content in high definition format and the at least one secondary stream of media content in any format lower than high definition format. The format lower than high definition format may be in relation to image resolution of the media content.

Preferably, the at least one primary stream of media content takes up a substantially higher bandwidth over the wireless network compared to the at least one secondary stream of media content, and the at least one primary stream of media content is dropped by the at least one wireless receiver device at areas of the wireless network with a degraded signal of the at least one primary stream of media content. The at least one primary stream of media content and the at least one secondary stream of media content may be transmitted either simultaneously or with a time lag. In addition, the degraded signal may be in a form which is not readable. Preferably, the substantially higher bandwidth relates to a maximum of 90% of an available bandwidth of the wireless network.

Preferably, the at least one wireless receiver device may be selected from, for example, a mobile phone, a media player, an e-book reader, a desktop computer, a portable computer and the like.

### DESCRIPTION OF DRAWINGS

In order that the present invention may be fully understood and readily put into practical effect, there shall now be described by way of non-limitative example only preferred embodiments of the present invention, the description being with reference to the accompanying illustrative drawings.

FIG. 1 shows a process flow for a method for transmitting media content.

FIG. 2 shows a process flow for a method for receiving media content.

FIG. 3 shows an overview of a system for enabling the methods of FIGS. 1 and 2.

### DESCRIPTION OF PREFERRED EMBODIMENTS

The present invention relates to various aspects of the distribution of media content over a wireless network, such as, a transmission aspect, a reception aspect and a system aspect. Further details of the aforementioned various aspects are provided in subsequent paragraphs of this section.

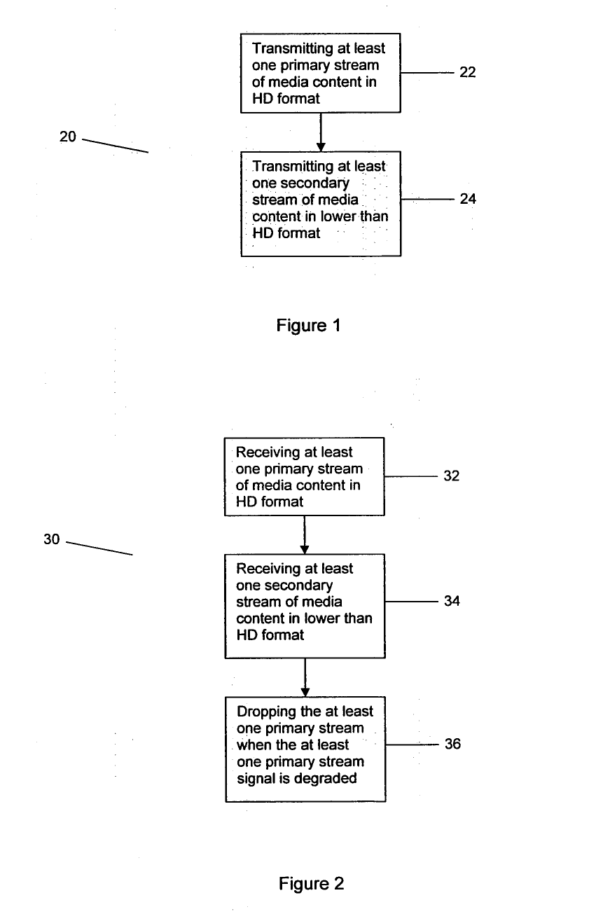

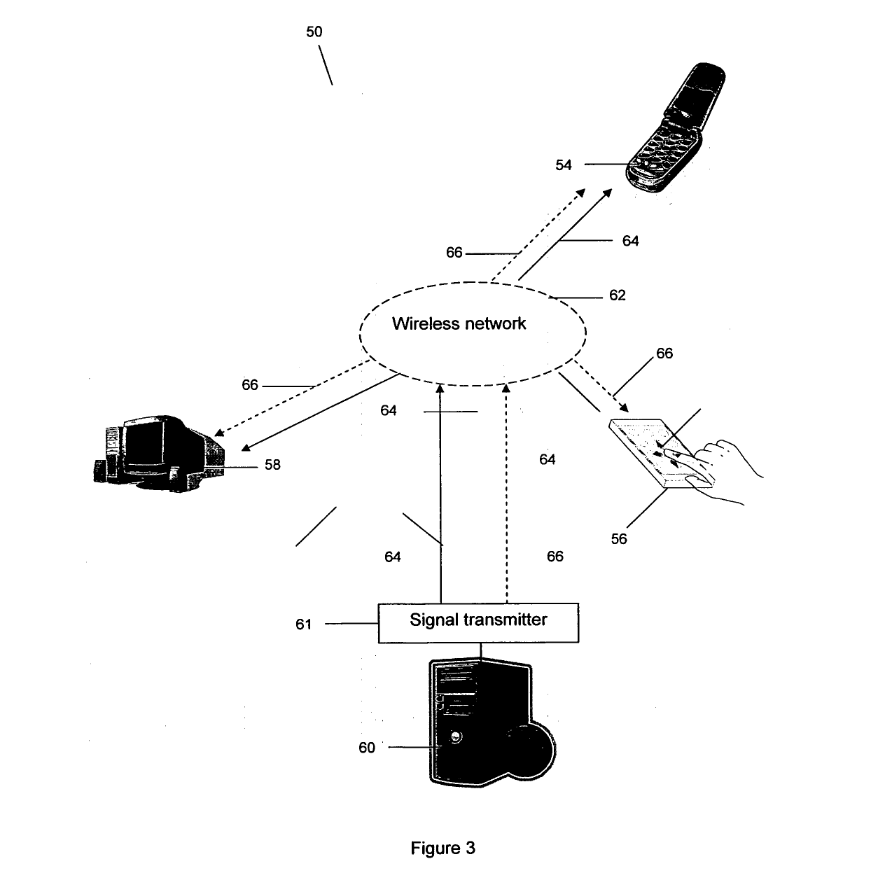

In a first aspect, referring to FIG. 1 and FIG. 3, there is shown a process flow for a method 20 for transmitting at least one stream of media content over a wireless network from a signal transmitter in the wireless network, and a system 50 which enables the method 20 respectively. Reference will be made to FIG. 1 for description of the method 20 and FIG. 3 will be used to illustrate how components of the system 50 enable the method 20. It should be appreciated that media content typically refers to video content which includes moving images and audio. The wireless network may be selected from, for example, WiMax, HSDPA, 4G and other similar high bandwidth networks.

The method 20 for transmitting at least one stream of media content over a wireless network 62 from a signal transmitter 61 in the wireless network 62 includes transmitting at least one primary stream 64 of media content in high definition format (22), and transmitting at least one secondary stream 66 of media content in any format lower than high definition format (24). The at least one primary stream 64 of media content and the at least one secondary stream 66 of media content may be transmitted either simultaneously or with a time lag. If there's a time lag, the at least one primary stream 64 may be transmitted either before the at least one secondary stream 66 or vice versa. The signal transmitter 61 may be coupled to a media content repository 60.

High definition format may relate to video content with image resolutions of at least, for example, 720p, 1080p, 1080i and the like. Similarly, the format lower than high definition format may relate to image resolution of the media content. The at least one secondary stream 66 of media content should contain identical content to the at least one primary stream 64 of media content.

In the method 20, the at least one primary stream 64 of media content takes up a substantially higher bandwidth over the wireless network 62 compared to the at least one secondary stream 66 of media content. The substantially higher bandwidth relates to a maximum of 90% of an available bandwidth of the wireless network 62. For example, in a 20 Mbps WiMax wireless network, the at least one primary stream 64 may take up 18 Mbps of the bandwidth available on the network, while correspondingly, the at least one secondary stream 66 may take up 2 Mbps of the available bandwidth.

The method 20 also includes the at least one primary stream 64 of media content being dropped by a signal receiver 54, 56, 58 at areas of the wireless network 62 with a degraded signal of the at least one primary stream 64 of media content. The signal receiver 54, 56, 58 may be incorporated into a device such as, for example, a mobile phone (54 as shown in FIG. 3), a media player (56 as shown in FIG. 3), an e-book reader, a desktop computer (58 as shown in FIG. 3), a portable computer and so forth. It should be noted that the degraded signal is in a form which is not readable. Correspondingly, when the at least one primary stream 64 is dropped, the signal receiver 54, 56, 58 is able to receive primarily the at least one secondary stream 66, leading to a higher possibility of the at least one secondary stream 66 being able to provide a readable signal at the signal receiver 54, 56, 58.

Thus, it is advantageous that a recipient at the signal receiver 54, 56, 58 is able to receive content transmitted through the at least one primary stream 66 (albeit in the format lower than high definition format) through the at least one secondary stream 66 even when the at least one primary stream 64 is received in a degraded state.

In a second aspect, referring to FIG. 2 and FIG. 3, there is shown a process flow for a method 30 for receiving at least one stream of media content over a wireless network at a signal receiver in the wireless network, and a system 50 which enables the method 30 respectively. Reference will be made to FIG. 2 for description of the method 30 and FIG. 3 will be used to illustrate how components of the system 50 enable the method 30. It should be appreciated that media content typically refers to video content which includes moving images and audio. The wireless network may be selected from, for example, WiMax, HSDPA, 4G and other similar high bandwidth networks.

The method 30 for receiving at least one stream of media content over a wireless network 62 at a signal receiver 54, 56, 58 in the wireless network 62 includes receiving at least one primary stream 64 of media content in high definition format (32). In addition, the method 30 also includes receiving at least one secondary stream 66 of media content in any format lower than high definition format (34). The at least one primary stream 64 of media content and the at least one secondary stream 66 of media content may be received either simultaneously or with a time lag. If there's a time lag, the at least one primary stream 64 may be received either before the at least one secondary stream 66 or vice versa. The signal receiver 54, 56, 58 may be incorporated into a device such as, for example, a mobile phone (54 as shown in FIG. 3), a media player (56 as shown in FIG. 3), an e-book reader, a desktop computer (58 as shown in FIG. 3), a portable computer and so forth.

High definition format may relate to video content with image resolutions of at least, for example, 720p, 1080p, 1080i and the like. Similarly, the format lower than high definition format may relate to image resolution of the media content. The at least one secondary stream 66 of media content should contain identical content to the at least one primary stream 64 of media content.

The method 30 also includes dropping the at least one primary stream 64 of media content at areas of the wireless network with a degraded signal of the at least one primary stream of media content (36). It should be noted that the degraded signal is in a form which is not readable. The at least one primary stream 64 of media content takes up a substantially higher bandwidth over the wireless network 62 compared to the at least one secondary stream 66 of media content. The substantially higher bandwidth relates to a maximum of 90% of an available bandwidth of the wireless network 62. For example, in a 20 Mbps WiMax wireless network, the at least one primary stream 64 may take up 18 Mbps of the bandwidth available on the network, while correspondingly, the at least one secondary stream 66 may take up 2 Mbps of the available bandwidth.

When the at least one primary stream 64 is dropped by the signal receiver 54, 56, 58, the signal receiver 54, 56, 58 is subsequently able to receive primarily the at least one secondary stream 66, leading to a higher possibility of the at least one secondary stream 66 being able to provide a readable signal at the signal receiver 54, 56, 58.

Thus, it is advantageous that a recipient at the signal receiver 54, 56, 58 is able to receive content transmitted through the at least one primary stream 66 (albeit in the format lower than high definition format) through the at least one secondary stream 66 even when the at least one primary stream 64 is received in a degraded state.

In a third aspect shown in FIG. 3, there is shown a system 50 for distributing media content over a wireless network. Constituent components of the system 50 have already been mentioned in the preceding paragraphs when describing the first and second aspects. It should be appreciated that media content typically refers to video content which includes moving images and audio. The wireless network may be selected from, for example, WiMax, HSDPA, 4G and other similar high bandwidth networks.

The system 50 includes at least one media content repository 60 which is able to transmit at least one primary stream 64 of media content in high definition format and at least one secondary stream 66 of media content in any format lower than high definition format. The at least one primary stream 64 of media content and the at least one secondary stream 66 of media content may be transmitted either simultaneously or with a time lag. If there's a time lag, the at least one primary stream 64 may be transmitted either before the at least one secondary stream 66 or vice versa.

High definition format may relate to video content with image resolutions of at least, for example, 720p, 1080p, 1080i and the like. Similarly, the format lower than high definition format may relate to image resolution of the media content. The at least one secondary stream 66 of media content should contain identical content to the at least one primary stream 64 of media content.

The system 50 also includes at least one wireless receiver device 54, 56, 58 able to receive the at least one primary stream 64 of media content in high definition format and the at least one secondary stream 66 of media content in any format lower than high definition format. The at least one wireless receiver device 54, 56, 58 may be a device such as, for example, a mobile phone (54 as shown in FIG. 3), a media player (56 as shown in FIG. 3), an e-book reader, a desktop computer (58 as shown in FIG. 3), a portable computer and so forth.

In the system 50, the at least one primary stream 64 of media content takes up a substantially higher bandwidth over the wireless network 62 compared to the at least one secondary stream 66 of media content. The substantially higher bandwidth relates to a maximum of 90% of an available bandwidth of the wireless network 62. For example, in a 20 Mbps WiMax wireless network, the at least one primary stream 64 may take up 18 Mbps of the bandwidth available on the network, while correspondingly, the at least one secondary stream 66 may take up 2 Mbps of the available bandwidth. The at least one primary stream 64 of media content is dropped by the at least one wireless receiver device 54, 56, 58 at areas of the wireless network with a degraded signal of the at least one primary stream 64 of media content. It should be noted that the degraded signal is in a form which is not readable.

When the at least one primary stream 64 is dropped by the signal receiver 54, 56, 58, the signal receiver 54, 56, 58 is subsequently able to receive primarily the at least one secondary stream 66, leading to a higher possibility of the at least one secondary stream 66 being able to provide a readable signal at the signal receiver 54, 56, 58.

Thus, it is advantageous that a recipient at the signal receiver 54, 56, 58 is able to receive content transmitted through the at least one primary stream 66 (albeit in the format lower than high definition format) through the at least one secondary stream 66 even when the at least one primary stream 64 is received in a degraded state.

Whilst there has been described in the foregoing description preferred embodiments of the present invention, it will be understood by those skilled in the technology concerned that many variations or modifications in details of design or construction may be made without departing from the present invention.

1. A method for transmitting at least one stream of media content over a wireless network from a signal transmitter in the wireless network, the method including:
transmitting at least one primary stream of media content in high definition format; and
transmitting at least one secondary stream of media content in any format lower than high definition format, the at least one secondary stream of media content containing identical content to the at least one primary stream of media content,
wherein the at least one primary stream of media content takes up a substantially higher bandwidth over the wireless network compared to the at least one secondary stream of media content, and wherein the at least one primary stream of media content is dropped by a signal receiver at areas of the wireless network with a degraded signal of the at least one primary stream of media content.

2. The method of claim 1, wherein the at least one primary stream of media content and the at least one secondary stream of media content are transmitted either simultaneously or with a time lag.

3. The method of claim 1, wherein the wireless network is selected from the group consisting of: WiMax, HSDPA, and 4G.

4. The method of claim 1, wherein the format lower than high definition format is in relation to image resolution of the media content.

5. The method of claim 1, wherein the degraded signal is in a form which is not readable.

6. The method of claim 1, wherein the signal transmitter is coupled to a media content repository.

7. The method of claim 1, wherein the substantially higher bandwidth relates to a maximum of 90% of an available bandwidth of the wireless network.

8. The method of claim 1, wherein the signal receiver is incorporated into a device selected from the group consisting of: a mobile phone, a media player, an e-book reader, a desktop computer, and a portable computer.

9. A method for receiving at least one stream of media content over a wireless network at a signal receiver in the wireless network, the method including:
receiving at least one primary stream of media content in high definition format;
receiving at least one secondary stream of media content in any format lower than high definition format, the at least one secondary stream of media content containing identical content to the at least one primary stream of media content; and
dropping the at least one primary stream of media content at areas of the wireless network with a degraded signal of the at least one primary stream of media content,
wherein the at least one primary stream of media content takes up a substantially higher bandwidth over the wireless network compared to the at least one secondary stream of media content.

10. The method of claim 9, wherein the at least one primary stream of media content and the at least one secondary stream of media content are received either simultaneously or with a time lag.

11. The method of claim 9, wherein the wireless network is selected from the group consisting of: WiMax, HSDPA, and 4G.

12. The method of claim 9, wherein the format lower than high definition format is in relation to image resolution of the media content.

13. The method of claim 9, wherein the degraded signal is in a form which is not readable.

14. (canceled)

15. The method of claim 9, wherein the substantially higher bandwidth relates to a maximum of 90% of an available bandwidth of the wireless network.

16. A system for distributing media content over a wireless network, the system including:
at least one media content repository able to transmit at least one primary stream of media content in high definition format and at least one secondary stream of media content in any format lower than high definition format, the at least one secondary stream of media content containing identical content to the at least one primary stream of media content; and
at least one wireless receiver device able to receive the at least one primary stream of media content in high definition format and the at least one secondary stream of media content in any format lower than high definition format,
wherein the at least one primary stream of media content takes up a substantially higher bandwidth over the wireless network compared to the at least one secondary stream of media content, and wherein the at least one primary stream of media content is dropped by the at least one wireless receiver device at areas of the wireless network with a degraded signal of the at least one primary stream of media content.

17. (canceled)

18. The system of claim 16, wherein the wireless network is selected from the group consisting of: WiMax, HSDPA, and 4G.

19. The system of claim 16, wherein the at least one wireless receiver device is selected from the group consisting of: a mobile phone, a media player, an e-book reader, a desktop computer, and a portable computer.

20. The system of claim 16, wherein the format lower than high definition format is in relation to image resolution of the media content.

21. The system of claim 16, wherein the degraded signal is in a form which is not readable.

22. The system of claim 16, wherein the substantially higher bandwidth relates to a maximum of 90% of an available bandwidth of the wireless network.
